(19) United States
(12) Patent Application Publication
(10) Pub. No.: US 2015/0213272 A1
(43) Pub. Date: Jul. 30, 2015

(54) CONJOINT VULNERABILITY IDENTIFIERS

(71) Applicants: Ofer Shezaf, Kibbutz Yiftah (IL); Sliman Mansour, Upper Gaillee (IL); Ben Feher, Ashdod (IL)

(72) Inventors: Ofer Shezaf, Kibbutz Yiftah (IL); Sliman Mansour, Upper Gaillee (IL); Ben Feher, Ashdod (IL)

(73) Assignee: HEWLETT-PACKARD DEVELOPEMENT COMPANY, L.P., Houston, TX (US)

(21) Appl. No.: 14/418,894

(22) PCT Filed: Jul. 31, 2012
(86) PCT No.: PCT/US2012/049039

§ 371 Date: Jan. 30, 2015

(51) Int. Cl. G06F 21/57; H04L 29/06

(52) U.S. Cl. CPC G06F 21/577; H04L 63/1433

(57) ABSTRACT

Conjoint vulnerability identifiers are determined for a vulnerability, and priorities are determined for the conjoint vulnerability identifiers. A highest priority conjoint vulnerability identifier is selected. An entry in a vulnerability cross reference table is created that associates the highest priority conjoint vulnerability identifier with a lower priority conjoint vulnerability identifier.

### BACKGROUND

Information security vulnerabilities are one of the major sources of security risks managed by system administrators. Some vulnerabilities may expose a network and its systems to unauthorized access to information or other malicious activities. Many tools exist to detect vulnerabilities, and an organization may use multiple tools to perform such operations.

### BRIEF DESCRIPTION OF DRAWINGS

The embodiments are described in detail with reference to the examples shown in the following figures:

FIG. 1 illustrates a vulnerability management system;

FIG. 2A illustrates an example of an authority priority table and

FIG. 2B illustrates an example of a cross reference table;

FIG. 3 illustrates a computer system that may be used as a platform for the vulnerability management system;

FIG. 4 illustrates a method of creating an entry in a vulnerability cross reference table; and

FIG. 5 illustrates a illustrates a method for performing a lookup in a vulnerability cross reference table.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a vulnerability management system determines a cross reference of conjoint vulnerability identifiers for each of multiple vulnerabilities. The conjoint vulnerability identifiers for the same vulnerability may be prioritized so a highest priority vulnerability identifier can be identified. The conjoint vulnerability identifiers for the same vulnerability may be determined from different authorities and stored in a vulnerability cross reference table. The priorities for the conjoint vulnerability identifiers may be based on the priorities of the authorities used to generate the conjoint vulnerability identifiers. Accordingly, if different security systems have different identifiers for the same vulnerability, the vulnerability cross reference table may be accessed to determine information about the vulnerability, regardless of the security system that detected the vulnerability. The information determined for the vulnerability may include remedial information, such as patches, and other up-to-date information about the vulnerability and the information may be provided by a highest priority authority.

A vulnerability may include an action that can be performed on a computer system that violates a security policy or rule related to the security of information and/or the security of a computer system. For example, a policy may restrict a user group to only access certain directories in a file system. An example of a rule may include that remote execution of a command can only be performed by a user with a system administrator ID. A vulnerability may exist if an application allows someone to execute a remote command under a non-system administrator ID. Examples of vulnerabilities may include allowing remote execution of commands by another user, unauthorized data access contrary to specified restrictions, facilitating a denial of service (e.g., by flooding), etc.

A conjoint vulnerability identifier identifies the vulnerability across a plurality of different security systems and information sources. A security system may include a vulnerability assessment tool, also referred to as a scanner, to detect a vulnerability. The scanner may perform tests that include operations performed by the scanner to detect different vulnerabilities. The scanner may scan computers, network devices, etc., in a computer network to detect vulnerabilities.

An authority provides a conjoint vulnerability identifier. The authority may be an information source providing information about existing vulnerabilities. One example of an information source is Common Vulnerabilities and Exposures (CVE), which is a dictionary of publicly known information security vulnerabilities and exposures maintained by the MITRE organization. Another example of an information source is the Open Source Vulnerability Database (OSVDB), which is an open source database maintained by the open source community. Other databases maintaining data about vulnerabilities may also be used as authorities. Each information source may assign an identifier to each vulnerability for which it has information, and the identifier may be used as a conjoint vulnerability identifier for each vulnerability.

An authority may provide a patch identifier as a conjoint vulnerability identifier. A patch identifier identifies a patch for a vulnerability. A patch may include a fix for a software program. A patch identifier may be provided by a vendor and may be associated with a vulnerability and used to identify the vulnerability across different security systems or other platforms.

An authority may also refer to a process for generating a conjoint vulnerability identifier. For example, a function that generates a conjoint vulnerability identifier from predetermined attributes of a vulnerability may be an authority.

The vulnerability management system may prioritize the authorities and generate a cross reference of prioritized conjoint vulnerability identifiers for each vulnerability based on the prioritized authorities. Some reasons for prioritizing authorities are the likelihood of an identifier being shared by different sources and the access the sources provide to additional information. The authorities may be prioritized according to one or more characteristics, such as reliability of information, level of recognition or adoption in a community, etc. The conjoint vulnerability identifiers may be used for vulnerability management, patch management, vulnerability alerting and intrusion detection. For example, the vulnerability management system may send alerts to system administrators if a vulnerability is detected, and the alerts may include information determined from a highest priority conjoint vulnerability identifier for the detected vulnerability. The vulnerability management system may also generate reports based on the information. In another example, a conjoint vulnerability identifier is used to determine remedial information that may specify priorities and fixes, such as patches, for the vulnerabilities. For example, a CVE ID for a vulnerability may be used to search the Internet or databases for the most up-to-date patches or information about a vulnerability, which may then be used by a system or a system administrator to fix a vulnerability.

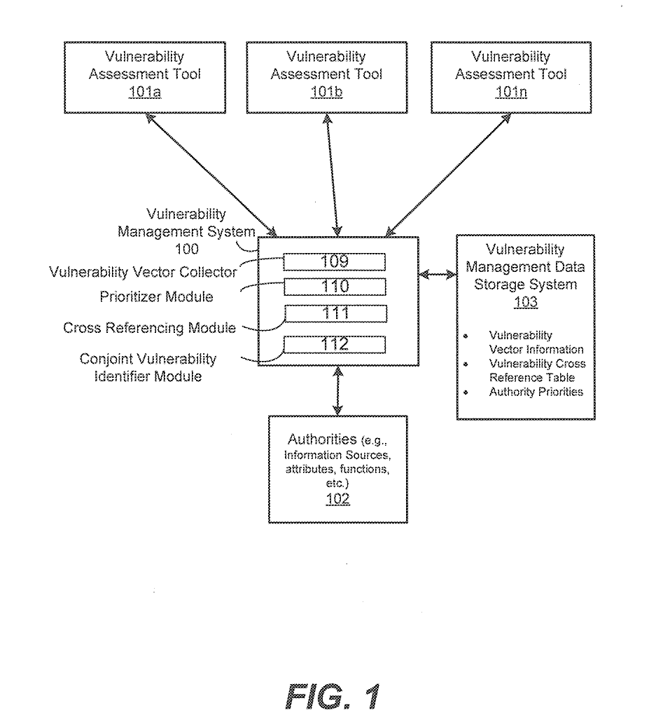

FIG. 1 shows a vulnerability management system 100 that may include a vulnerability vector collector 109, a prioritizer module 110, a cross referencing module 111 and a conjoint vulnerability identifier module 112. The vulnerability vector collector 109 may collect information about vulnerabilities and tests that may be performed by the vulnerability assessment tools 101 (shown as 101a-n) to detect the vulnerabilities. The vulnerability vector collector 109 may retrieve the information from libraries or other data structures used by the vulnerability assessment tools 101. The information about the tests may include descriptive text describing the tests, titles of the tests, information describing signatures and rules, and logic, which may be comprised of computer code or scripts executed by a tool to detect a vulnerability, and other information. In some instances some of the information may be unavailable, such as the logic, but the remaining information may be used for matching. The vulnerability assessment tools 101 are examples of security systems that may detect vulnerabilities. The vulnerability assessment tools 101 may comprise scanners that run the tests and each test may detect different vulnerabilities. A scanner may include a computer program comprised of machine readable instructions to run the tests. The tests may assess computers, networks or applications. The scanners may detect different types of vulnerabilities, such as vulnerabilities related to configuration settings, database vulnerabilities, application vulnerabilities, etc.

The information collected by the vulnerability vector collector 109 may include attributes associated with the information collected from the vulnerability assessment tools 101. Examples of the attributes include an identifier of a system that is vulnerable or causing a vulnerability, a vulnerability location, vulnerability type, date, etc. A vulnerability location may include a uniform resource location (URL), file location, or other data storage location. Vulnerability type is a category of vulnerabilities, such as SQL injection (related to database vulnerabilities), cross-site scripting (related to web application vulnerabilities), etc.

The conjoint vulnerability identifier module 112 determines conjoint vulnerability identifiers for vulnerabilities. The conjoint vulnerability identifiers may be determined from the authorities 102. In one example, the authority is an information source, such as CVE or OSVDB. The conjoint vulnerability identifier module 112 may identify information collected by the vulnerability vector collector 109 to search the information source for a conjoint vulnerability identifier.

In an example, the vulnerability vector collector 109 collects information for a vulnerability from the vulnerability assessment tool 101a. The conjoint vulnerability identifier module 112 may identify a pattern from the collected information. For example, the pattern may be a patch ID. For example, the pattern is [0-9a-z]{8}{12}, which may represent the patch ID assigned by a vendor. The patch ID is for a patch for the vulnerability for which a conjoint vulnerability identifier is being determined. Known patterns may be stored in the vulnerability management data storage system 103. A pattern may include any predetermined information that can be detected. The pattern may include a string of characters.

The conjoint vulnerability identifier module 112 may identify the pattern in descriptive text collected from the vulnerability assessment tool 101a that describes a test or the vulnerability. Pattern searching techniques, such as regular expression, may be used for the pattern detection. If the pattern is identified, the pattern may be used to search the information source to detect a match. For example, CVE is searched. CVE includes entries for vulnerabilities. Each entry may include a CVE ID; text comprised of an overview describing the vulnerability; an impact of the vulnerability describing the effects on systems and its users; references to advisories, solutions, patches and tools; vulnerable software and versions; and/or technical details. If an entry for a vulnerability in CVE includes the pattern [0-9a-z]{8}{12}, the entry is considered a match. String searching techniques, such as Naïve string searching or finite-state automaton may be used to identify matches. The CVE ID of the matching entry may be stored as the conjoint vulnerability identifier module for the vulnerability. If the pattern is not found in any entries of the information sources, the pattern may be stored as the conjoint vulnerability identifier for the vulnerability.

The attributes determined from the information collected from a vulnerability assessment tool may be used to search an information source to determine a conjoint vulnerability identifier. For example, the attributes may be used to query the entries in the security vulnerabilities information source 102 for matches. For example, system name, vulnerability location and vulnerability type are determined by the vulnerability vector collector 109 for a particular test performed by the vulnerability assessment tool 101a. If these three attributes are found in an entry in an authority comprising an information source, then the entry is considered a match and an ID from the information source may be used as the conjoint vulnerability identifier.

In one example, even if all the attributes cannot be identified in an entry of the security vulnerabilities information source, a match may still be identified. For example, system name, vulnerability location and vulnerability type are the attributes being compared to the entries. If only two of the attributes are found in an entry, the entry may still be considered a match. In another example, a partial match for an attribute may be considered a match for that attribute. For example, the URL extracted from description of a test provided by the vulnerability assessment tool 101a partially matches a vulnerability location in an entry in the security vulnerabilities information source. The partial match may be considered a match if most of the characters match. In another example, a hierarchal taxonomy of vulnerability types is used to determine matches. For example, if a parent or a child of an entry has a matching attribute, then the entry may be considered a match. In another example, a level of matching is determined if a fuzzy matching function is employed. If the level is above a threshold, the result is assumed to be a match and if below a threshold, the potential match may be presented for further manual verification.

In another example, the conjoint vulnerability identifier module 112 determines a conjoint vulnerability identifier based on one of the authorities 102 that is a function for determining a conjoint vulnerability identifier. For example, a conjoint vulnerability identifier is determined from any combination of the name and/or version of the vulnerable system, the vulnerability category and the time or date of discovery of the vulnerability. This information may be collected from a vulnerability assessment tool by the vulnerability vector collector 109. For example, the vulnerability assessment tool XYZ1 can detect an SQL injection vulnerability in the “forums” module of a web site building software ABC, and the vulnerability is first discovered on January 2011. The authority that is a function for determining the conjoint vulnerability identifier concatenates the name of the vulnerable system, the vulnerability category and the time or date of discovery of the vulnerability to determine the conjoint vulnerability identifier. For example, the conjoint vulnerability identifier is determined to be XYZ1-FORUMS-SQLI-2011-01. If a different vulnerability assessment tool can detect the same vulnerability, it uses the same function to generate the conjoint vulnerability identifier, which should be the same or similar as XYZ1-FORUMS-SQLI-2011-01 because it is determined from the same or similar information. Combinations of attributes or vulnerability related information other than name, category, and date may be used to determine the conjoint vulnerability identifier. In yet another example, a conjoint vulnerability identifier may be an ID assigned by the vulnerability assessment tool or another system. In another example, certain attributes determined from the information collected by the vulnerability vector collector 109 are used as the conjoint vulnerability identifier.

The prioritizer module 110 determines priorities for the authorities 102. The priorities may be selected by a user or by another system and stored in the vulnerability management data storage system 103. The prioritizer module 110 may retrieve the priorities from the vulnerability management data storage system 103.

The cross referencing module 111 stores conjoint vulnerability identifiers for each vulnerability in the vulnerability management data storage system 103. The cross referencing module 111 also stores priorities for the conjoint vulnerability identifiers based on the priorities of the authorities. The conjoint vulnerability identifiers and their priorities may be stored in a vulnerability cross reference table. The vulnerability cross reference table includes entries that associate conjoint vulnerability identifiers for the same vulnerability with each other. The conjoint vulnerability identifiers, for example, include the conjoint vulnerability identifiers determined by the conjoint vulnerability identifier module 112. The vulnerability cross reference table may be updated with new entries if new conjoint vulnerability identifiers are identified or if new associations between conjoint vulnerability identifiers are determined. Some examples of determining new associations may include the conjoint vulnerability identifier module 112 identifying two different identifiers for the same vulnerability. Multiple identifiers for the same vulnerability may be retrieved from information sources such as OSVDB or CVE. A mapping table between identifiers for the same vulnerability may be available from a vendor mapping patches to CVE numbers. Entries for these new associations are created in the vulnerability cross reference table.

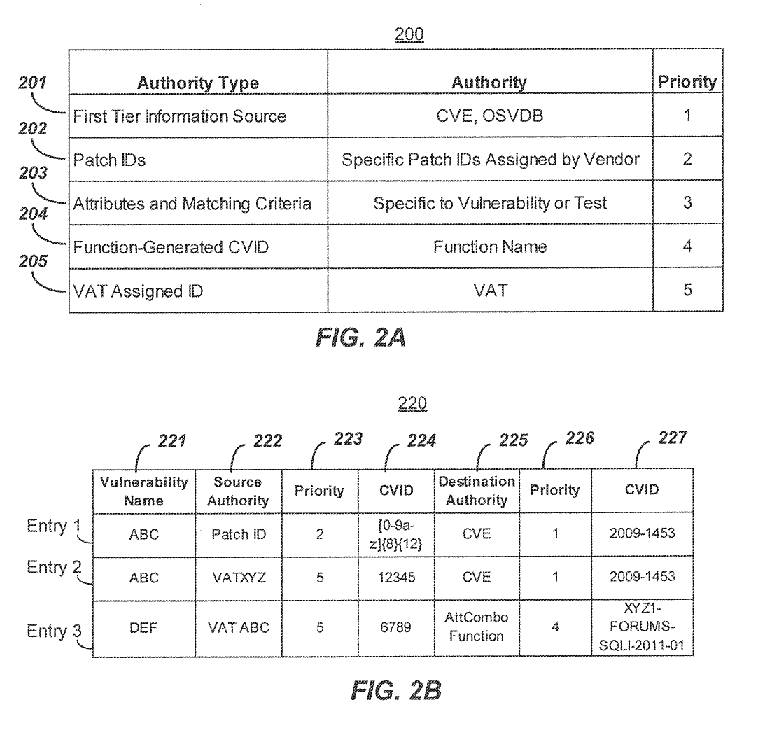

The vulnerability management data storage system 103 may comprise a database or some other type of data storage system. Information associated with vulnerabilities may also be stored in the vulnerability management data storage system 103. For example, the vulnerability management data storage system 103 may store the information collected by the vulnerability vector collector 109 and priority information, such as shown in FIG. 2A.

FIG. 2A shows an example of priorities table 200 showing priorities for each authority. The priorities in the priorities table 200 may be entered by a user and may be stored in the vulnerability data management system 103. The table 200 includes an authority name and/or authority type and a priority for each authority. For example, the highest priority authority 201 is information source, which may be CVE or OSVDB. The second highest priority authority 202 is patch IDs and the patch IDs may be determined by the vendor of the vulnerable system for which the patch is applied. The third highest priority may include attributes of a vulnerability or other matching criteria, which may be determined from information collected from a vulnerability assessment tool or matching rules generated by a user. The fourth highest priority authority 204 is function-generated IDs. For example, a function may be used to determine a conjoint vulnerability identifier based on a combination of attributes of each vulnerability. A fifth highest priority authority 205 may be IDs generated by the vulnerability assessment tool, abbreviated as VAT in the table 200. The higher priority authorities may be the authorities that are most likely to be used many different systems. Also, a conjoint vulnerability identifier may be given the same priority as the authority used to generate the conjoint vulnerability identifier. Also, different vulnerability assessment tools may be more likely to have CVE information for the same vulnerability when compared to IDs generated by lower-priority authorities. Thus, the CVE is given a higher priority.

FIG. 2B shows an example of a vulnerability cross reference table 220 that may be stored in the vulnerability data management storage system 103 shown in FIG. 1. The table 220 includes entries for different vulnerabilities, such as entries 1-3. The table 220 may have many more entries than shown. The table 220 may have fields for a source authority 222 and a destination authority 225, and priority fields 223 and 226 and conjoint vulnerability identifier (CVID) fields 224 and 227 for each of the source and destination authorities. The table 220 may be used to identify a highest priority conjoint vulnerability identifier for a vulnerability. The source authority may represent a lower priority authority than a destination authority. The conjoint vulnerability identifier for the source authority may be used as an index to perform a lookup to determine if the table 220 includes an associated conjoint vulnerability identifier having a higher priority as further described below. The vulnerability name field 222 is shown in the table 220 but may not be used.

Entries 1 and 2 are for the vulnerability “ABC”. For example, the lower priority conjoint vulnerability identifiers in entries 1 and 2 (i.e., [0-9a-z]{8}{12} and 12345) may be used to identify the higher priority conjoint vulnerability identifier 2009-1435 for the same vulnerability. If new lower priority conjoint vulnerability identifiers are determined for “ABC”, entries may be created mapping the lower priority conjoint vulnerability identifiers to 2009-1435. In this example there is only one entry for “DEF” and the highest priority conjoint vulnerability identifier is priority 4. If other higher priority conjoint vulnerability identifiers are determined for “DEF”, entries may be created mapping the known lower priority conjoint vulnerability identifiers for “DEF” to the higher priority conjoint vulnerability identifier for “DEF”.

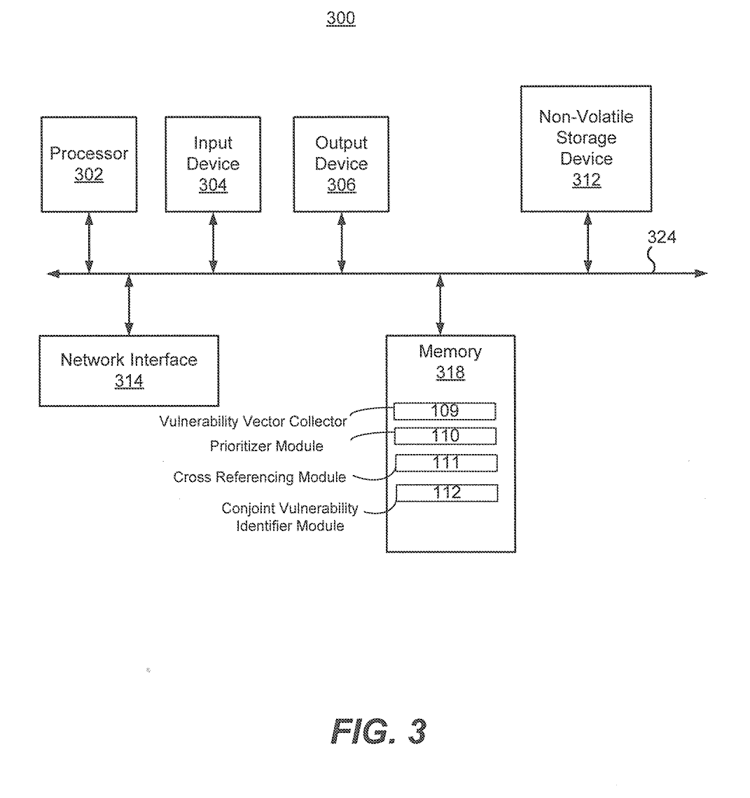

FIG. 3 shows a block diagram of a computer system 300 that may be used for a platform for the vulnerability management system 100. The computer system 300 is shown comprising hardware elements that may be electrically coupled via a bus 324. The hardware elements may include a processor 302, an input device 304 (e.g., keyboard, touchscreen, etc.), and an output device 306 (e.g., display, speaker, etc.). The computer system 300 may also include storage devices, such as memory 318 and a non-volatile storage device 312 (e.g., solid state storage, hard disk, etc.). The storage device 312 and memory 318 are examples of non-transitory computer readable storage media that may store machine readable instructions. For example, the components of the system 100 shown in FIG. 1 may comprise machine readable instructions stored at runtime in the memory 318 and executed by the processor 302. Also, the methods and functions and operations described herein may be embodied ad machine readable instructions that can be executed by the processor 302 to perform the methods and functions and operations. The vulnerability vector collector 109, the prioritizer module 110, the cross referencing module 111 and the conjoint vulnerability identifier module 112 are shown in the memory 318 for runtime operation. The non-volatile storage device 312 may store data and applications. The computer system 300 may additionally include a network interface 314, which may be wireless and/or a wired network interface. The computer system 300 may communicate with the vulnerability assessment tools 101 shown in FIG. 1 and the authorities 102 that are information sources via the network interface 314. The vulnerability management data storage system 103 shown in FIG. 1 may be hosted with the vulnerability management system 100 or may be hosted on another device, such as a database server, whereby the computer system 300 may connect to the vulnerability management data storage system 103 via the network interface 314. It should be appreciated that the computer system 300 may have numerous variations from that described above. For example, customized hardware might also be used and/or particular elements might be implemented in hardware, software (including portable software, such as applets), or both.

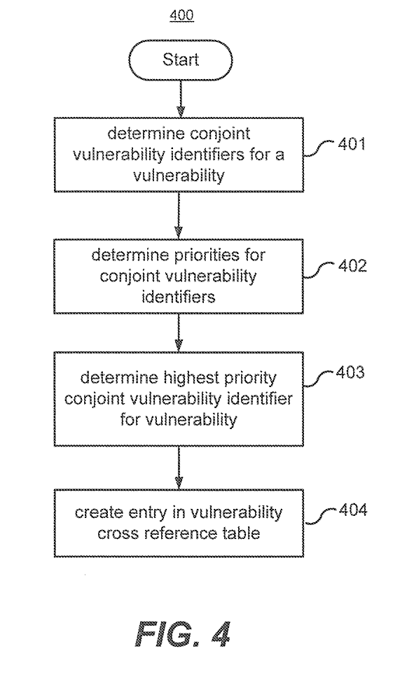

FIG. 4 shows an example of a method 400 for determining a highest priority conjoint vulnerability identifier for a vulnerability. The method 400 is described with respect to the vulnerability management system 100 shown in FIG. 1 by way of example. The method 400 may be performed by other systems.

At 401, conjoint vulnerability IDs are determined from different authorities for a vulnerability. For example, the vulnerability vector collector 109 collects information for a vulnerability from the vulnerability assessment tools 101 and the conjoint vulnerability identifier module 112 determines conjoint vulnerabilities for the vulnerability from the authorities. For example, a conjoint vulnerability identifier is determined from an identifier assigned by a vulnerability assessment tool. Another conjoint vulnerability identifier is determined from a function that determines the conjoint vulnerability identifier by combining attributes. Other conjoint vulnerability identifiers may include attributes of the vulnerability, CVE ID, etc.

At 402, priorities for conjoint vulnerabilities are determined. For example, the prioritizer module 110 stores priorities for authorities in the priorities table 200, such as shown in FIG. 2A. The priority of each conjoint vulnerability identifier determined at 401 may be the same as the priority for the authority used to determine the conjoint vulnerability identifier.

At 403, a highest priority conjoint vulnerability identifier from the conjoint vulnerability identifiers determined at 401 is determined.

At 404, an entry is created in the vulnerability cross reference table 220 shown in FIG. 2B associating a lower priority conjoint vulnerability identifier determined at 401 with the highest priority conjoint vulnerability identifier. An entry may be created in the table 220 for each lower priority conjoint vulnerability identifier. For example referring to FIG. 2B, entries 1 and 2 are created because three conjoint vulnerability identifiers were determined: 2009-1453, [0-9a-z]{8}{12}, and 12345 for the vulnerability “ABC”. Two entries were created to map the lower priority conjoint vulnerability identifiers, i.e., [0-9a-z]{8}{12} and 12345, to the highest priority conjoint vulnerability identifier 2009-1453. Additional examples for creating an entry mapped to the highest priority are now described. Assume an association is determined where A is a conjoint vulnerability identifier for a source authority and B is a conjoint vulnerability identifier for a destination authority, and A and B are for the same vulnerability. The association is referred to as A->B, Assume B is found as a source in an entry in the table 220 (e.g., B->C) for the same vulnerability. Then, an entry is created in the table for A->C and not for A->B because C is the highest priority conjoint vulnerability identifier associated with A for the same vulnerability. Continuing with the example where there is an association A->B, assume that instead of B, A is found as a source in an entry in the table 220 (e.g., A->C). If B has a higher priority than C, an entry A->B is created in the table 220, and the entry for A->C is changed to C->B, effectively removing the entry A->C from the table 220. If C has a higher priority than B, an entry for B->C is created in the table 220.

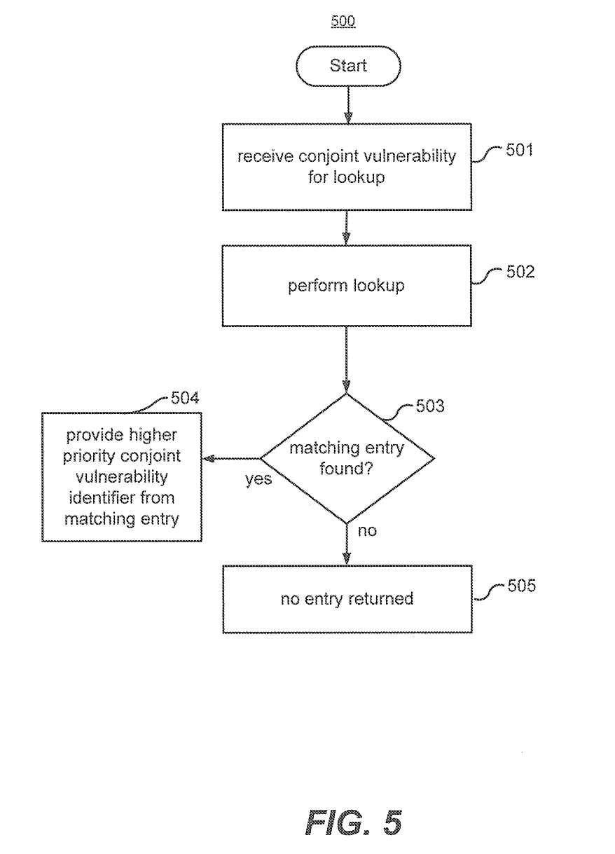

FIG. 5 shows an example of a method 500 for performing a lookup on a vulnerability cross reference table and enriching the table. The method 500 is described with respect to the vulnerability management system 100 shown in FIG. 1 by way of example. The method 500 may be performed by other systems.

At 501, a conjoint vulnerability identifier is received for the lookup. The conjoint vulnerability identifier may be received from an information source or determined from an authority or otherwise provided to the vulnerability management system 100.

At 502, a lookup is performed and at 503 a determination is made if a matching entry is found. For example, a search is performed on the vulnerability cross reference table 220 to determine if there is a matching entry. The search may be performed by the cross referencing module 111 shown in FIG. 1. In one example, referring to FIG. 2B, the received conjoint vulnerability identifier is VATXYZ, and a lookup is performed with VATXYZ. Entry 2 is a matching entry.

If a matching entry is found, at 504, the higher priority conjoint vulnerability identifier determined from the matching entry is provided. For example, for the matching entry 2, the higher priority conjoint vulnerability identifier 2009-1453 is provided. The higher priority conjoint vulnerability identifier may be provided to a user or an information source via a network or a display. The higher priority conjoint vulnerability identifier may be used to determine information about the vulnerability from the CVE.

If no matching entry is found at 502, no entry is returned. An entry may be subsequently created in the vulnerability cross reference table for conjoint vulnerability identifier received at 501. For example, if a destination authority is subsequently determined for the conjoint vulnerability identifier received at 501, an entry may be created in the table 220. The table 220 can be enriched with new entries whenever a determination is made that a lower priority conjoint vulnerability identifier is associated with a higher priority conjoint vulnerability for the same vulnerability.

While the embodiments have been described with reference to examples, various modifications to the described embodiments may be made without departing from the scope of the claimed embodiments.

What is claimed is:

1. A method comprising:
determining a plurality of conjoint vulnerability identifiers from a plurality of authorities for a vulnerability;
determining priorities for the plurality of conjoint vulnerability identifiers from priorities for the plurality of authorities;
determining, by a processor, a highest priority conjoint vulnerability identifier from the plurality conjoint vulnerability identifiers; and
storing an entry in a cross reference table associating the highest priority conjoint vulnerability identifier with a lower priority conjoint vulnerability identifier.

2. The method of claim 1, wherein the storing an entry comprises storing an entry in the cross reference table for each of the plurality of conjoint vulnerability identifiers having a lower priority than the highest priority conjoint vulnerability identifier.

3. The method of claim 1, wherein the plurality of authorities from highest priority to lowest priority comprise a vulnerability information source maintained by an organization, a pattern determined from patch information, predetermined attributes associated with a target system determined to exhibit the vulnerability, a function applied to predetermined attributes, and a vulnerability assessment tool assigning an identifier to the vulnerability.

4. The method of claim 1, wherein the determining of the plurality of conjoint vulnerability identifiers comprises:
collecting information about the vulnerability from a vulnerability assessment tool;
determining whether the collected information identifies an entry from a vulnerability information source maintained by an organization, wherein the vulnerability information source comprises entries for vulnerabilities and each entry includes a vulnerability identifier and other information about the vulnerability; and
if the collected information identifies an entry from a vulnerability information source, using the vulnerability identifier from the information source as one of the plurality of conjoint vulnerability identifiers.

5. The method of claim 1, wherein the determining of the plurality of conjoint vulnerability identifiers comprises:
collecting information about the vulnerability from a vulnerability assessment tool;
identifying a pattern from the collected information describing a patch for the vulnerability; and
determining one of the plurality of conjoint vulnerability identifiers from the pattern.

6. The method of claim 1, wherein the determining of the plurality of conjoint vulnerability identifiers comprises:
collecting information about the vulnerability from a vulnerability assessment tool;
determining, from the collected information, attributes of a target system capable of having the vulnerability; and
determining one of the plurality of conjoint vulnerability identifiers from the attributes.

7. The method of claim 6, wherein the attributes comprise name or version of the vulnerable system, vulnerability type, and an indication of when the vulnerability was discovered.

8. The method of claim 6, the determining of one of the plurality of conjoint vulnerability identifiers from the combination of the attributes comprises:
applying a combining function to the attributes to determine the conjoint vulnerability identifier.

9. The method of claim 1, wherein the cross reference table comprises multiple entries, and each entry associates a lower priority conjoint vulnerability identifier with a higher priority conjoint vulnerability identifier.

10. The method of claim 1, wherein each entry in the cross reference table includes a source conjoint vulnerability identifier mapped to a destination conjoint vulnerability identifier having a higher priority, and the method comprises:
determining first and second conjoint vulnerability identifiers for the vulnerability, wherein the second conjoint vulnerability identifier has a higher priority than the first conjoint vulnerability identifier;
determining whether the cross reference table includes an entry having the second conjoint vulnerability identifier as a source conjoint vulnerability identifier; and
if the entry is identified and the entry is for the vulnerability, creating a new entry in the cross reference table mapping the first conjoint vulnerability identifier to the destination conjoint vulnerability identifier of the identified entry.

11. The method of claim 1, comprising:
determining whether the cross reference table includes an entry having the first conjoint vulnerability identifier as a source conjoint vulnerability identifier;
if the entry is identified and the entry is for the vulnerability, determining which of the destination conjoint vulnerability identifier from the identified entry and the second conjoint vulnerability identifier has a higher priority;
if the second conjoint vulnerability identifier has the higher priority, creating a new entry in the cross reference table mapping the first conjoint vulnerability identifier to the second conjoint vulnerability identifier and changing the identified entry to map the destination conjoint vulnerability from the identified entry to the second conjoint vulnerability; and
if the destination conjoint vulnerability identifier from the identified entry has the higher priority, creating a new entry in the cross reference table mapping the second conjoint vulnerability to the destination conjoint vulnerability identifier from the identified entry.

12. A non-transitory computer readable medium including machine readable instructions that when executed by at least one processor cause the at least one processor to:
store a cross reference table, wherein each entry in the cross reference table includes a source conjoint vulnerability identifier mapped to a destination conjoint vulnerability identifier having a higher priority than the source;
determine a plurality of conjoint vulnerability identifiers from a plurality of authorities for a vulnerability;
determine priorities for the plurality of conjoint vulnerability identifiers from priorities for the plurality of authorities;
determine a highest priority conjoint vulnerability identifier from the plurality conjoint vulnerability identifiers; and
create an entry in the cross reference table mapping a lower priority conjoint vulnerability identifier with the highest priority conjoint vulnerability identifier.

13. A vulnerability management system comprising:
a data storage device to store a vulnerability cross reference table; and
a processor to
determine priorities for a plurality of conjoint vulnerability identifiers determined for a same vulnerability based on the priorities of the authorities, wherein each of the conjoint vulnerability identifiers is determined from one of the authorities,
select a highest priority conjoint vulnerability identifier from the plurality conjoint vulnerability identifiers, and
store an entry in the vulnerability cross reference table associating the highest priority conjoint vulnerability identifier with a lower priority conjoint vulnerability identifier of the plurality of conjoint vulnerability identifiers.

14. The vulnerability management system of claim 13, wherein the processor is to store multiple entries in the vulnerability cross reference table, and each entry associates a lower priority conjoint vulnerability identifier with the highest priority conjoint vulnerability identifier.

15. The vulnerability management system of claim 13, wherein the processor is to receive a conjoint vulnerability identifier for a vulnerability and perform a lookup in the vulnerability cross reference table to determine if there is a matching entry in the vulnerability cross reference table including a higher priority conjoint vulnerability identifier for the vulnerability.
